(19) United States
(12) Patent Application Publication
(10) Pub. No.: US 2007/0129037 A1
(43) Pub. Date: Jun. 7, 2007

(54) MUTE PROCESSING APPARATUS AND METHOD

(75) Inventors: Wen-Chuan Lian, Shenzhen (CN); Wen-Sheng Tsai, Shenzhen (CN); Hai-Sheng Li, Shenzhen (CN); Kuan-Hong Hsieh, Shenzhen (CN); Duo Liu, Shenzhen (CN); Cheng Wang, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,524

(22) Filed: Aug. 17, 2006

(30) Foreign Application Priority Data
Dec. 3, 2005 (CN) 200510102095.9

(51) Int. Cl. H04B 1/18; H04B 1/16

(52) U.S. Cl. 455/223; 455/174.1; 455/194.1

(57) ABSTRACT

A mute processing method used in a multi-person communication system is provided. The method is capable of automatically sending mute frames when there are no sound inputs from terminals of the multi-person communication system. The method includes the steps of: collecting input signals from a microphone; obtaining a maximum amplitude of the input signals within a present time span; sending a mute frame if each maximum amplitude of the input signals within each of previous continuous time spans is less than a predetermined amplitude and the maximum amplitude of the input signals within the present time span is still less than the predetermined amplitude, otherwise, coding the input signals within the present time span; and outputting the mute frame or coded signals. A related apparatus is also provided.

### TECHNICAL FIELD

The present invention relates to mute processing apparatuses and methods, and particularly to a mute processing apparatus and method for automatically sending mute frames during a multi-person communication over via a network.

### GENERAL BACKGROUND

With the development of communication networks and associated services, a multi-person communication has been introduced and regarded as a typical service in the communication networks, such as the Public Switched Telephone Network (PSTN) and the Voice over Internet Protocol (VoIP) Network. Furthermore, the multi-person communication has been also adopted in a network telephone conversation or a network TV conversation. Such multi-person communication can support multiple persons simultaneously to communicate, and deliver speech data from broadcaster(s) to the listeners.

In order to provide a friendly communication environment, it is critical for the multi-person communication to utilize system resources to reduce delay, namely to deliver the speech data to each person as soon as possibly. With respect to the delay problem, controlling a transferring amount of the speech data is an effective method to solve the delay problem. However, current multi-person communication systems indiscriminately transfer all data regardless of sound data or soundless data over the communication network. In other words, the soundless data is send over the communication network as well as the sound data. As a result, the soundless data increases a loading of the communication network and the transferring amount of the speech data. Consequently, a delay phenomenon may appear due to the negligible soundless data, therefore, a service quality of the multi-person communication system may be weakened due to the delay phenomenon.

What is needed, therefore, is a mute processing apparatus and method used in the multi-person communication system, which can automatically send mute frames when there are no sound inputs from terminals of the multi-person communication system without sending unnecessary soundless data, thereby reducing the transferring amount of the speech data due to rather less sizes of the mute frames as compared to the soundless data.

### SUMMARY

A mute processing apparatus is provided. The apparatus is capable of automatically sending mute frames when persons don't talk or keep mute during a multi-person communication over a network. The apparatus mainly includes a sampling unit, an amplitude analyzer, a coding unit, a processing unit, and an output unit. The sampling unit is for collecting input signals from a microphone. The amplitude analyzer is for obtaining a maximum amplitude of input signals within a present time span. The coding unit is for coding the input signals within the present time span. The processing unit is for sending a mute frame within the present time span if each maximum amplitude of the input signals within each of previous continuous time spans is less than a predetermined amplitude and the maximum amplitude of the input signals within the present time span is still less than the predetermined amplitude, otherwise, controlling the coding unit to code the input signals within the present time span. The output unit is for outputting the mute frame from the processing unit or coded signals from the coding unit.

A mute processing method is also provided. The method includes the steps of: (a) collecting input signals from a microphone; (b) obtaining a maximum amplitude of input signals within a present time span; (c) sending a mute frame if each maximum amplitude of the input signals within each of previous continuous time spans is less than a predetermined amplitude and the maximum amplitude of the input signals within the present time span is still less than the predetermined amplitude, otherwise, coding the input signals within the time span; and (d) outputting the mute frame or coded signals.

Other advantages and novel features will be drawn from the following detailed description with reference to the attached drawing, in which:

### BRIEF DESCRIPTION OF DRAWINGS

FIG. 1 is a schematic diagram of a hardware infrastructure of a mute processing apparatus for automatically sending mute frames during a multi-person communication over a network in accordance with a preferred embodiment of the present invention; and

FIG. 2 is a flowchart of a preferred mute processing method for automatically sending mute frames during a multi-person communication over a network by utilizing the apparatus of FIG. 1.

### DETAILED DESCRIPTION

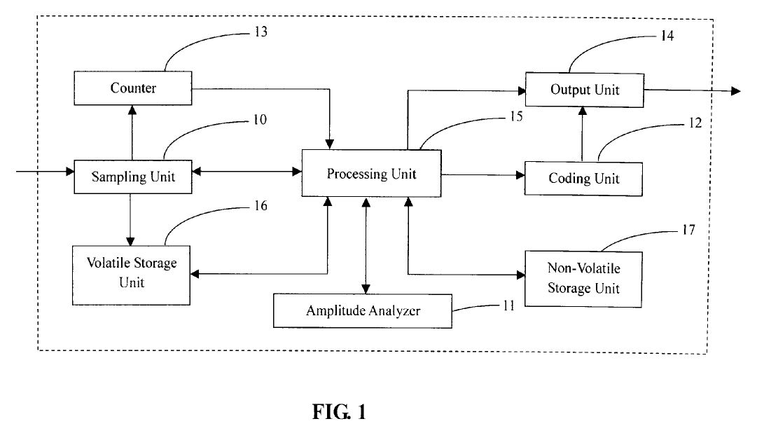

FIG. 1 is a schematic diagram of a hardware infrastructure of a mute processing apparatus (hereinafter, “the apparatus”) in accordance with a preferred embodiment of the present invention. The apparatus is used in a multi-person communication system, and preferably, is incorporated into each terminal of the multi-person communication system. The apparatus is capable of automatically sending mute frames when there are no sound inputs on any terminal ends during a multi-person communication, thereby reducing a loading of a network responsible for transmitting data throughout the terminals. The apparatus includes a sampling unit 10, an amplitude analyzer 11, a coding unit 12, a counter 13, an output unit 14, a processing unit 15, a volatile storage unit 16, and a non-volatile storage unit 17.

The sampling unit 10 is for collecting input signals from a microphone (not shown) connected to the apparatus of the terminal.

The amplitude analyzer 11 is for obtaining a maximum amplitude of the input signals from the microphone within a present time span. That is, the amplitude analyzer 11 regards the input signals within one time span as an input period, and obtains the maximum amplitude of each input period.

If the maximum amplitude of the input period is equal to or greater than a predetermined amplitude, that means the terminal of the multi-person communication is inputting sound within the present time span, therefore, a speech coding operation is required on the input signals of the input period to obtain coded signals to be sent out over the network.

If maximum amplitudes of multiple continuous input periods are a combination consisting of maximum amplitudes greater than (equal to) and less than the predetermined amplitude, that means the terminal of the multi-person communication may have one or more input pauses over multiple continuous time spans, therefore, the speech coding operation is required on input signals of each input period over the multiple continuous time spans to obtain coded signals to be sent out through the network.

If each maximum amplitude of each of multiple previous continuous input periods is less than the predetermined amplitude, and the maximum amplitude of a next input period is also less than the predetermined amplitude, that means there is no sound input from the terminal of the multi-person communication within the multiple previous continuous time span and the time span of the next input period, therefore, a mute frame is sent within the time span of the next input period instead of performing a speech coding operation on the input signals of the next input period.

The coding unit 12 is for performing the speech coding operation on the input signals within the time span, that is, for coding the input signals of the input period. The counter 13 provides a value for indicating a count of continuous input periods whose maximum amplitude is less than the predetermined amplitude. Furthermore, an initial value of the counter 13 is zero. The output unit 14 is for outputting coded signals from the coding unit 13 or the mute frame.

The processing unit 15 is for controlling the components of the apparatus, i.e., the sampling unit 10, the amplitude analyzer 11, the coding unit 12, the counter 13, the output unit 14, the volatile storage unit 16, and the non-volatile storage unit 17.

The processing unit 15 resets the value of the counter 13 with the initial value and simultaneously signals the coding unit 12 to perform the speech coding operation on the input signals of the input period within the present time span, if the maximum amplitude of the input period is equal to or greater than the predetermined amplitude.

The processing unit 15 also signals the coding unit 12 to perform the sound coding operation on each input signals of the input period within the multiple continuous time spans, if the maximum amplitudes of multiple continuous input periods are the combination of maximum amplitudes greater than (equal to) and less than the predetermined amplitude, or each maximum amplitude of each of multiple continuous input periods is less than the predetermined amplitude. The processing unit 15 further increases the value of the counter 13 by one while simultaneously performing the speech code operation on the input signals of each input period.

Moreover, the processing unit 15 sends the mute frame instead of performing the sound coding operation on the input signals of the input period and increasing the value of the counter 13, if each maximum amplitude of each of multiple previous continuous input periods is less than the predetermined amplitude and the maximum amplitude of the next input period is still less than the predetermined amplitude. That is, if the value of the counter 13 is equal to a predetermined value and the maximum amplitude of the next input period is less than the predetermined amplitude, the processing unit 15 signals the output unit 14 to output the mute frame.

Therefore, in the case when the value of the counter 13 equals to the predetermined value and each maximum amplitude of each of multiple continuous input periods is still less than the predetermined amplitude, the apparatus simply sends the mute frame within each corresponding time span of the input periods. Otherwise, the apparatus sends coded signals within each corresponding time span. Because a size of the mute frame is relatively smaller than a size of the input period coded signals, a transferring amount of the mute frame is consequentially less than a transferring amount of the coded signals of the input period. As a result, a loading of the network is available to be reduced due to less transferring amount of mute frames, thereby eliminating delay phenomena.

Additionally, the volatile storage unit 16 is configured for storing the input signals of each input period and the maximum amplitude of the input signals of each input period. The non-volatile storage unit 17 is configured for storing the predetermined amplitude and the predetermined value.

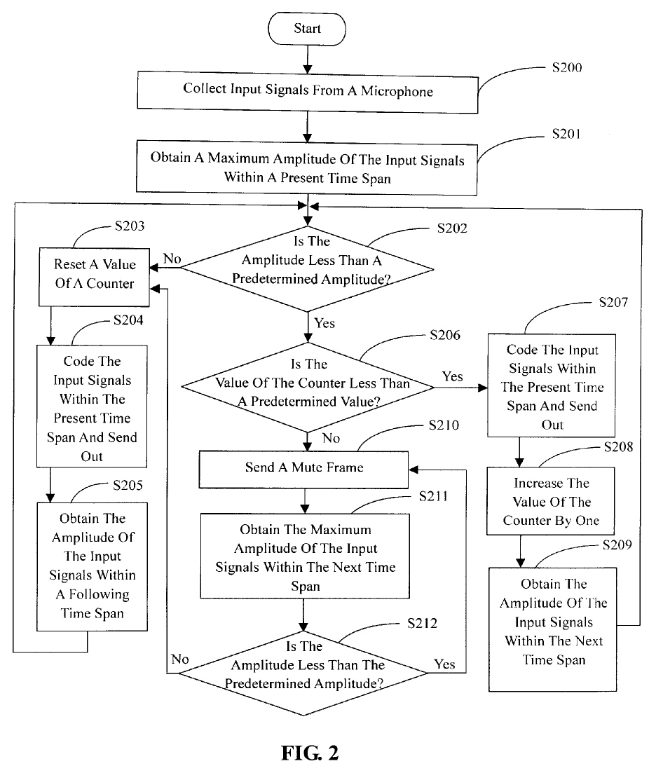

FIG. 2 is a flowchart of a preferred mute processing method for automatically sending mute frames during the multi-person communication over the network by utilizing the apparatus of FIG. 1. In step S200, the sampling unit 10 collects the input signals from the microphone connected to the terminal of the multi-person communication system. In step S201, the amplitude analyzer 11 obtains the maximum amplitude of the input signals within the present time span. In step S202, the processing unit 15 determines whether the maximum amplitude obtained is less than the predetermined amplitude.

If the maximum amplitude obtained is not less than the predetermined amplitude, in step S203, the processing unit 15 resets the value of the counter 13. In step S204, the coding unit 12 performs the speech coding operation on the present input signals of the input period, and the output unit 14 sends out the coded signals from the coding unit 12 over the network. In step S205, the amplitude analyzer 11 obtains the maximum amplitude of the input signals within a next time span, and the procedure goes to step S202 described above.

If the maximum amplitude obtained is less than the predetermined amplitude, in step S206, the processing unit 15 determines whether the value of the counter 13 is less than the predetermined value.

If the value of the counter 13 is less than the predetermined value, in step S207, the coding unit 12 performs the speech coding operation on the present input signals of the input period, and the output unit 14 sends out the coded signals from the coding unit 12 over the network. In step S208, the processing unit increases the value of the counter 13 by one. In step S209, the amplitude analyzer 11 obtains the maximum amplitude of the input signals within the next time span, and the procedure goes to step S202 described above.

If the value of the counter 13 is not less than the predetermined value, that means there is no sound input from the terminal of the multi-person communication within the present time span, in step S210, the processing unit 15 signals the output unit 14 to output the mute frame over the network, thereby reducing the loading of the network.

In step S211, the amplitude analyzer 11 obtains the maximum amplitude of the input signals within a next time span. In step S212, the processing unit 15 determines whether the maximum amplitude of the next time span obtained is less than the predetermined amplitude. If so, that means there is still no sound input from the terminal of the multi-person communication, and the procedure goes to step S211 described previously to output the mute frame again through the network. If not, that means the terminal of the multi-person communication is inputting sound, and the procedure goes to step S203 described above.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. A mute processing apparatus for automatically sending mute frames during a multi-person communication over a network, the apparatus comprising:
a sampling unit, for collecting input signals from a microphone;
an amplitude analyzer, for obtaining a maximum amplitude of the input signals within a present time span;
a coding unit, for coding the input signals within the present time span;
a processing unit, for sending a mute frame within the time span if each maximum amplitude of the input signals within each of previous continuous time spans is less than a predetermined amplitude and the maximum amplitude of the input signals within the present time span is still less than the predetermined amplitude, otherwise controlling the coding unit to code the input signals within the present time span; and
an output unit, for outputting the mute frame from the processing unit or coded signals from the coding unit.

2. The apparatus according to claim 1, further comprising a counter for providing a value indicating a count of continuous time spans in which the maximum amplitude of each of the continuous time spans is less than the predetermined amplitude.

3. The apparatus according to claim 2, wherein the processing unit sends the mute frame within the present time span, if the value of the counter is equal to a predetermined value and the maximum amplitude of the input signals within the present time span is less than the predetermined amplitude.

4. The apparatus according to claim 3, wherein the value of the counter increases by one if the maximum amplitude of the input signals within the present time span is less than the predetermined amplitude.

5. The apparatus according to claim 4, wherein the processing unit resets the value of the counter if the maximum amplitude of the input signals within the present time span is equal to or greater than the predetermined amplitude.

6. The apparatus according to claim 5, further comprising a volatile storage unit for storing the input signals of each time span and the maximum amplitude of the input signals of each time span.

7. The apparatus according to claim 6, further comprising a non-volatile storage unit for storing the predetermined amplitude and the predetermined value.

8. A mute processing method for automatically sending mute frames during a multi-person communication over a network, the method comprising the steps of:
collecting input signals from a microphone;
obtaining a maximum amplitude of input signals within a present time span;
sending a mute frame if each maximum amplitude of the input signals within each of previous continuous time spans is less than a predetermined amplitude and the maximum amplitude of the input signals within the present time span is still less than the predetermined amplitude, otherwise, coding the input signals within the present time span; and
outputting the mute frame or coded signals.

9. The method according to claim 8, further comprising the step of: providing a counter with a value indicating a count of continuous time spans in which the maximum amplitude of each of the continuous time spans is less than the predetermined amplitude.

10. The method according to claim 9, wherein the sending step further comprising the step of: sending the mute frame if the value of the counter is equal to a predetermined value and the maximum amplitude of the input signals is less than the predetermined amplitude.

11. The method according to claim 10, further comprising the step of: increasing the value of the counter by one if the maximum amplitude of the input signals within the present time span is less than the predetermined amplitude.

12. The method according to claim 11, further comprising the step of: resetting the value of the counter if the maximum amplitude of the input signals within the present time span is equal to or greater than the predetermined amplitude.

13. The method according to claim 12, further comprising the step of: providing a volatile storage unit and a non-volatile storage unit, the volatile storage unit being configured for storing the input signals of each time span and the maximum amplitude of the input signals of each time span, and the non-volatile storage unit being configured for storing the predetermined amplitude and the predetermined value.
